(19) United States
(12) Patent Application Publication
(10) Pub. No.: US 2014/0272602 A1
(43) Pub. Date: Sep. 18, 2014

(54) SOLID-STATE LITHIUM ION CONDUCTOR AND ELECTROCHEMICAL DEVICE

(71) Applicant: TDK CORPORATION, Tokyo (JP)

(72) Inventors: Tokuhiko HANDA, Tokyo (JP); Chieko SHIMIZU, Tokyo (JP)

(73) Assignee: TDK CORPORATION, Tokyo (JP)

(21) Appl. No.: 14/218,572

(22) Filed: Mar. 18, 2014

(30) Foreign Application Priority Data
Mar. 18, 2013 (JP) 2013-055423
Dec. 27, 2013 (JP) 2013-270705

(51) Int. Cl. H01M 10/0562; H01M 10/0525

(52) U.S. Cl. CPC H01M 10/0562; H01M 10/0525
USPC 429/322; 423/263; 423/303

(57) ABSTRACT

A solid-state lithium ion conductor includes: Li, P, and S; and at least one metal element selected from Sc, Y, La, Ce, Pr, Nd, Sm, Eu, Gd, Tb, Dy, Ho, Er, Tm, Yb, Lu, Zr, Hf, V, Nb, Ta, Cr, Mo, W, Mn, Re, Ru, Os, Co, Rh, Ir, Ni, Pd, Pt, Zn, Cd, and Hg.

### CROSS-REFERENCE TO RELATED APPLICATION

This application claims priority from Japanese Patent Application Nos. 2013-055423 filed with the Japan Patent Office on Mar. 18, 2013, and 2013-27705 filed with the Japan Patent Office on Dec. 27, 2013, the entire contents of which are hereby incorporated by reference.

### BACKGROUND

1. Technical Field

The present disclosure relates to a solid-state lithium ion conductor and an electrochemical device.

2. Related Art

A lithium ion secondary battery has high capacity per volume or weight and lithium ion secondary batteries have been therefore widely used for mobile devices, and so on. Research and development have been actively carried out to use lithium ion secondary batteries in the application thereof in higher capacity, such as electric vehicles.

A lithium ion secondary battery mainly includes a positive electrode, a negative electrode, and a liquid electrolyte disposed between the positive electrode and the negative electrode. The positive electrode and the negative electrode have conventionally been formed using slurry-like or paste-like coating liquid for forming electrodes. This coating liquid includes an electrode active material for a positive electrode or a negative electrode, a binder, and a conductive auxiliary agent.

The liquid electrolyte includes a flammable organic solvent. Thus, the lithium ion secondary battery takes structural countermeasures to prevent liquid leakage. The larger the size and the capacity of the lithium ion secondary battery become, the more the need of the structural countermeasure for preventing liquid leakage increases.

The all-solid-state lithium ion secondary battery uses an inflammable or flame-retardant solid-state lithium ion conductor instead of the liquid electrolyte. In other words, the all-solid-state lithium ion secondary battery does not contain the flammable organic solvent. For this reason, the all-solid-state lithium ion secondary battery has a possibility of drastically solving the problem of the liquid leakage of the conventional lithium ion secondary battery. Thus, the all-solid-state lithium ion secondary battery has been aggressively studied.

On the other hand, in recent years, developments have been advanced on the materials with a potential of 5 V or more relative in lithium metal reference in order to improve the capacity of the lithium ion secondary battery. The liquid electrolyte, however, has a narrow potential window. Thus the battery with liquid electrolyte may cause the decomposition of the electrolyte on battery operation. In contrast, the solid-state lithium ion conductor has a wide potential window. Thus, the solid-state lithium ion conductor is used to suppress electrolyte decomposition, providing the battery with high capacity.

As an example of such a solid-state lithium ion conductor, WO07/066,539 describes a solid-state lithium ion conductor containing lithium (Li), phosphorus (P), and sulfur (S). This solid-state lithium ion conductor has high ion conducting properties. In spite of this fact, a solid-state lithium ion conductor having higher ion conducting properties (i.e., high ion conductivity) has been desired for obtaining a lithium ion secondary battery with higher performance.

JP-A-2001-6674 and JP-A-2011-124081 have studied solid-state lithium ion conductors added with metal elements and describe the examples thereof. In JP-A-2001-6674, there is described a technique intended for providing a conductor material with electron conductivity to give a solid-state lithium ion conductor with extremely high electron conductivity. Likewise, in JP-A-2011-124081, there is also described a technique for providing a solid-state lithium ion conductor with high electron conductivity. In other words, these patent documents do not substantially describe any excellent solid-state lithium ion conductor having both high ion conductivity and low electron conductivity.

JP-A-2011-129407 has studied a solid-state lithium ion conductor added with lithium, phosphorus, sulfur, and a metalloid element such as germanium or antimony, and describes the example thereof. Such a conductor can exert an effect of suppressing the amount of hydrogen sulfide generated by exposing the solid-state lithium ion conductor to the atmosphere. However, such a document does not substantially describe any improved ion conductivity.

### SUMMARY

A solid-state lithium ion conductor of the present disclosure includes: Li, P, and S; and at least one metal element selected from Sc, Y, La, Ce, Pr, Nd, Sm, Eu, Gd, Tb, Dy, Ho, Er, Tm, Yb, Lu, Zr, Hf, V, Nb, Ta, Cr, Mo, W, Mn, Re, Ru, Os, Co, Rh, Ir, Ni, Pd, Pt, Zn, Cd, and Hg.

### BRIEF DESCRIPTION OF DRAWINGS

FIG. 1 is a Z-contrast image of a solid-state lithium ion conductor obtained by transmission electron microscopy in Example 10;

FIG. 2 is an electron diffraction image at Point 01 in FIG. 1;

FIG. 3 is an electron diffraction image at Point 02 in FIG. 1;

FIG. 4 is an electron diffraction image at Point 03 in FIG. 1;

FIG. 5 is an electron diffraction image at Point 04 in FIG. 1; and

FIG. 6 is an electron diffraction image at Point 05 in FIG. 1.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

An object of the present disclosure is to provide a solid-state lithium ion conductor having both high ion conductivity and low electron conductivity, and provide an electrochemical device including the same.

A solid-state lithium ion conductor according to the present disclosure for achieving the above object contains lithium (Li), phosphorus (P), and sulfur (S) and moreover at least one metal element selected from Sc, Y, La, Ce, Pr, Nd, Sm, Eu, Gd, Tb, Dy, Ho, Er, Tm, Yb, Lu, Zr, Hf, V, Nb, Ta, Cr, Mo, W, Mn, Re, Ru, Os, Co, Rh, Ir, Ni, Pd, Pt, Zn, Cd, and Hg.

For providing an all-solid-state lithium ion secondary battery with high performance, the solid-state lithium ion conductor is required to have high ion conductivity. On the other hand, the electron conductivity of the solid-state lithium ion conductor is minimized because of the reason given below. Since the solid-state lithium ion conductor has electron conductivity, the all-solid-state lithium ion secondary battery can advance self-discharging. This makes it difficult to maintain the charged state.

Hence, nonmetal elements and metalloid elements have been examined whether any of them could be used as structural element other than Li in a solid-state lithium ion conductor having lithium ion conductivity.

In this case, the addition of a metal element has been considered to be a cause of increasing the electron conductivity of the solid-state lithium ion conductor. However, the present inventors have unexpectedly found that the addition of a specific metal element causes an increase in only ion conductivity while suppressing an increase in electron conductivity.

Moreover, the solid-state lithium ion conductor according to the present disclosure may include a crystalline phase. Thus, higher ion conductivity can be obtained.

The metal element in the solid-state lithium ion conductor according to the present disclosure may be trivalent or tetravalent. In this case, higher ion conductivity can be obtained.

Moreover, the solid-state lithium ion conductor according to the present disclosure may contain 0.55 to 4.31 mol % of the metal element. In this case, higher ion conductivity can be obtained.

Moreover, in the solid-state lithium ion conductor according to the present disclosure, the molar ratio of Li to P may be in a range of 2.1 to 4.6. In this case, higher ion conductivity can be obtained.

Moreover, an electrochemical device according to the present disclosure contains the aforementioned solid-state lithium ion conductor.

According to the present disclosure, the solid-state lithium ion conductor having high ion conductivity and low electron conductivity can be provided.

An embodiment of the present disclosure is hereinafter described. Note that the present disclosure is not limited to the embodiment below. The components described below include the component easily conceived by a person skilled in the art or the component that is substantially the same. The components described below can be combined as appropriate.

A solid-state lithium ion conductor according to this embodiment contains lithium (Li), phosphorus (P), and sulfur (S) and moreover at least one metal element selected from Sc, Y, La, Ce, Pr, Nd, Sm, Eu, Gd, Tb, Dy, Ho, Er, Tm, Yb, Lu, Zr, Hf, V, Nb, Ta, Cr, Mo, W, Mn, Re, Ru, Os, Co, Rh, Ir, Ni, Pd, Pt, Zn, Cd, and Hg.

One of the reasons for the improvement of ion conductivity with the addition of metal element may be of the following: for example, the substitution of the metal element for P in the Li—P—S crystal distorts or increases the crystal lattice. This facilitates the diffusion of Li ions. Alternatively, the coordination of S in the metal element added in the amorphous portion increases the density of the solid-state lithium ion conductor.

One of the reasons for failure in improvement of electron conductivity with the addition of metal element may be of the following: for example, the crystal structure in which P of the Li—P—S crystal is substituted by the metal element or the structure of the amorphous portion to which the metal element is added suppresses or prevents effectively the hopping of valence electrons between the metal elements, which is considered to lead to the electron conductivity.

Above all, the metal element is, for example, trivalent or tetravalent. Examples of the trivalent or tetravalent metal element includes Sc, Y, La, Ce, Pr, Nd, Sm, Eu, Gd, Tb, Dy, Ho, Er, Tm, Yb, Lu, Zr, Hf, V, Nb, Ta, Cr, Mo, W, Re, Ru, Os, Rh, Ir, and Pt.

The proportion of the metal element in the entire material of the solid-state lithium ion conductor is, for example, in a range of 0.55 to 4.31 mol %. By setting the proportion of the metal element in this range, the lithium ion conductivity is further improved.

In addition, the molar ratio of Li to P is, for example, in a range of 2.1 to 4.6. In this case, the higher ion conductivity can be obtained.

The solid-state lithium ion conductor is an amorphous material free of a crystalline phase, a crystalline material having a crystalline phase, or a mixture of the amorphous material and the crystalline material. In particular, the solid-state lithium ion conductor may be the crystalline material or the mixture of the amorphous material and the crystalline material. The mixture of the amorphous material and the crystalline material can be obtained by generating a crystalline phase by thermally processing an amorphous material.

The amorphous material can be formed by a mechanical milling method or a melt quenching method. In particular, the mechanical milling method is a simple method. In this mechanical milling method, the glass can be formed at room temperature, whereby the manufacture apparatus can be simplified and the process cost can be reduced. According to the melt quenching method, the amorphous material can be obtained by mixing raw materials, melting the materials and then rapidly cooling the materials. The melting temperature is, for example, approximately 600° C. to 1000° C.

The mixture of the amorphous material and the crystalline material can be obtained by thermally processing the amorphous material obtained by the mechanical milling method or the melt quenching method. The mixture obtained thus has higher ion conductivity than the amorphous material. The heat treatment temperature is, for example, approximately 200° C. to 400° C.

The crystalline material is formed by, for example, a solid-state-phase reaction method. The reaction temperature is, for example, approximately 400° C. to 700° C.

The solid-state lithium ion conductor according to this embodiment is manufactured starting from a single element contained therein or a compound of the elements, for example. Above all, a sulfide of each element is used. For example, lithium sulfide, phosphorus sulfide, or the sulfides of the other metal elements are used.

The solid-state lithium ion conductor according to this embodiment may contain cations other than Li, P, or the metal elements. The concentration of the cations is, for example, less than 5 wt %. When the concentration of the cations is more than or equal to 5 wt %, the ion conductivity is decreased. The concentration of the cations is determined using an inductively coupled plasma optical emission spectrometry apparatus (ICP-OES) or X-ray fluorescence analyzer (XRF), for example.

The solid-state lithium ion conductor according to this embodiment may contain anions other than S. As the anion other than S, specifically, the solid-state lithium ion conductor may contain oxygen, for example. The concentration of oxygen is, for example, less than 10 wt %. When the concentration of the anions is more than or equal to 10 wt %, the ion conductivity is decreased. The concentration of oxygen can be determined by, for example, an oxygen-nitrogen analyzer or a scanning electron microscope (SEM-EDX) having an energy dispersive X-ray spectrometry apparatus.

In the electrochemical device, the solid-state lithium ion conductor is supported between a pair of electrodes. Examples of such an electrochemical device include a lithium ion secondary battery, a primary battery, an electrochemical capacitor, a fuel cell, and a gas sensor.

Above all, the lithium ion secondary battery according to this embodiment includes the solid-state lithium ion conductor according to this embodiment having both high ion conductivity and low electron conductivity. Therefore, the lithium ion secondary battery is free from the risk of liquid leakage and has high capacity.

The lithium ion secondary battery has a structure in which the solid-state lithium ion conductor is held between a positive electrode mixture and a negative electrode mixture. The lithium ion secondary battery may contain the solid-state lithium ion conductor according to this embodiment in each of the positive electrode mixture and the negative electrode mixture, which contain the active material and the conductive auxiliary agent.

As the active material, a known material can be employed. Examples of the positive electrode active material include: an oxide of a transition metal, such as LiCoO₂, LiNiO₂, LiNi₁₋ₓCoₓO₂, LiCo_{1/3}Ni_{1/3}Mn_{1/3}O₂, and LiMn₂O₄; a material having an olivine structure represented by a general formula LiMPO₄ (where M represents Fe, Mn, Co, Ni, V, VO, Cu, or the like); a sulfide of a transition metal, such as TiS₂, MoS₂, or FeS₂; vanadium oxide; and an organic sulfur compound.

Examples of the negative electrode active material include: carbon materials such as graphite, carbon black, carbon fiber, and carbon nanotube; alloy materials such as Si, SiO, Sn, SnO, CuSn, and LiIn; oxides such as Li₄Ti₅O₁₂; and Li metal.

Examples of the conductive auxiliary agent include: carbon black such as acetylene black or Ketjen black, natural graphite, synthetic graphite, carbon fiber, and other carbon materials, and conductive ceramics.

### Example 1

### Preparation of Sample

Li₂S (Kojundo Chemical Laboratory, product No. LII06PB) and P₂S₅ (Aldrich, product No. 232106) were respectively weighed so that the molar ratio thereof becomes 85:15, and mixed, thereby providing a mixture. Then, 1 mole of ZnS (Kojundo Chemical Laboratory, product No. ZNI10PB) was weighed relative to 99 moles of this mixture. Zn is divalent. The weighed material contains 0.28 mol % of Zn relative to the entire material. The molar ratio of Li to P is 5.7. The weighed material was entirely placed in a planetary ball mill (Fritsch). The material was pulverized and mixed for 6 hours at 350 rpm, thereby providing powder mixture. This powder mixture, the solid-state lithium ion conductor particles, was subjected to XRD measurement. As a result, a clear diffraction peak was not observed. Thus, it was confirmed that there is no crystalline phase in the solid-state lithium ion conductor particles. In other words, the solid-state lithium ion conductor particles were in the amorphous state. The solid-state lithium ion conductor particles were placed in a tablet forming machine and compressed therein, thereby providing a green pellet of the solid-state lithium ion conductor. The green pellet extracted from the tablet forming machine was attached to a jig where a pressure of approximately 1 MPa was applied thereto. Thus, an evaluation sample was obtained. An electrode was formed of stainless steel (SUS).

### Evaluation of Sample

The ion conductivity of the obtained evaluation sample was determined. The ion conductivity was determined using an apparatus of product type 1260 and 1287 manufactured by Solartron with a frequency ranging from 0.1 Hz to 1 MHz by an AC impedance method. As a result, the ion conductivity was 2.5×10⁴ S/cm. Moreover, the electron conductivity of the evaluation sample was determined by a DC method. As a result, the electron conductivity was 3.2×10⁻⁸ S/cm. Thus, the electron conductivity was negligibly low.

### Example 2

In a manner similar to Example 1, Li₂S and P₂S₅ were pulverized and mixed, thereby providing powder mixture. This powder mixture was subjected to heat treatment for 2 hours at 240° C. The powder mixture after this heat treatment was subjected to XRD measurement. As a result, a plurality of clear diffraction peaks was observed. Thus, the generation of a crystalline phase was confirmed. The ion conductivity was determined in a manner similar to Example 1. As a result, the ion conductivity was 4.8×10⁻⁴ S/cm. Moreover, the electron conductivity of the evaluation sample was determined by a DC method. As a result, the electron conductivity was 3.4×10⁻⁸ S/cm. Thus, the electron conductivity was negligibly low.

### Example 3

Li₂S and P₂S₅ were respectively weighed so that the molar ratio thereof becomes 85:15, and mixed, thereby providing a mixture. Relative to 99.5 moles of this mixture, 0.5 moles of La₂S₃ (Kojundo Chemical Laboratory, product No. LAI07PB) were weighed. La is trivalent. The weighed material contains 0.28 mol % of La relative to the entire material. The molar ratio of Li to P is 5.7. The weighed material was pulverized and mixed in a manner similar to Example 1, thereby providing the powder mixture. This powder mixture, i.e., solid-state lithium ion conductor particles were subjected to XRD measurement. As a result, a clear diffraction peak was not observed. It was confirmed that there is no crystalline phase in the solid-state lithium ion conductor particles. In other words, the solid-state lithium ion conductor particles are in the amorphous state. The ion conductivity was determined in a manner similar to Example 1. As a result, the ion conductivity was 3.5×10⁻⁴ S/cm. Moreover, the electron conductivity was determined by a DC method. As a result, the electron conductivity was 2.6×10⁻⁸ S/cm. Thus, the electron conductivity was negligibly low.

### Example 4

Li₂S and P₂S₅ were pulverized and mixed in a manner similar to Example 1, thereby providing a powder mixture. This powder mixture was subjected to heat treatment for 2 hours at 250° C. The powder mixture after the heat treatment was subjected to XRD measurement. As a result, a plurality of clear diffraction peaks was observed. Thus, the generation of a crystalline phase was confirmed. The ion conductivity was determined in a manner similar to Example 1. As a result, the ion conductivity was 6.4×10⁻⁴ S/cm. Moreover, the electron conductivity was determined by a DC method. As a result, the electron conductivity was 2.1×10⁻⁸ S/cm. Thus, the electron conductivity was negligibly low.

### Example 5

Li₂S and P₂S₅ were respectively weighed so that the molar ratio thereof becomes 85:15, and mixed, thereby providing a mixture. Relative to 99 moles of this mixture, 1 mole of NbS₂ (Kojundo Chemical Laboratory, product No. NBI07PB) was weighed. Nb is tetravalent. The weighed material contains 0.28 mol % of Nb relative to the entire material. The molar ratio of Li to P is 5.7. The weighed material was pulverized and mixed in a manner similar to Example 1, thereby providing the powder mixture. This powder mixture was subjected to heat treatment for 2 hours at 260° C. The powder mixture after the heat treatment was subjected to XRD measurement. As a result, a plurality of clear diffraction peaks was observed. Thus, the generation of a crystalline phase was confirmed. The ion conductivity was determined in a manner similar to Example 1. As a result, the ion conductivity was 5.9×10⁻⁴ S/cm. Moreover, the electron conductivity was determined by a DC method. As a result, the electron conductivity was 2.9×10⁻⁸ S/cm. Thus, the electron conductivity was negligibly low.

### Example 6

Li₂S and P₂S₅ were respectively weighed so that the molar ratio thereof becomes 85:15, and mixed, thereby providing a mixture. Relative to 90 moles of this mixture, 10 moles of La₂S₃ were weighed. La is trivalent. The weighed material contains 5.35 mol % of La relative to the entire material. The molar ratio of Li to P is 5.7. The weighed material was pulverized and mixed in a manner similar to Example 1, thereby providing the powder mixture. This powder mixture was subjected to heat treatment for 2 hours at 240° C. The powder mixture after the heat treatment was subjected to XRD measurement. As a result, a plurality of clear diffraction peaks was observed. Thus, the generation of a crystalline phase was confirmed. The ion conductivity was determined in a manner similar to Example 1. As a result, the ion conductivity was 6.2×10⁻⁴ S/cm. Moreover, the electron conductivity was determined by a DC method. As a result, the electron conductivity was 2.3×10⁻⁸ S/cm. Thus, the electron conductivity was negligibly low.

### Example 7

Li₂S and P₂S₅ were respectively weighed so that the molar ratio thereof becomes 85:15, and mixed, thereby providing a mixture. Relative to 99 moles of this mixture, 1 mole of La₂S₃ was weighed. La is trivalent. The weighed material contains 0.55 mol % of La relative to the entire material. The molar ratio of Li to P is 5.7. The weighed material was pulverized and mixed in a manner similar to Example I, thereby providing the powder mixture. This powder mixture was subjected to heat treatment for 2 hours at 240° C. The powder mixture after the heat treatment was subjected to XRD measurement. As a result, a plurality of clear diffraction peaks was observed. Thus, the generation of a crystalline phase was confirmed. The ion conductivity was determined in a manner similar to Example 1. As a result, the ion conductivity was 9.5×10⁻⁴ S/cm. Moreover, the electron conductivity was determined by a DC method. As a result, the electron conductivity was 2.2×10⁻⁸ S/cm. Thus, the electron conductivity was negligibly low.

### Example 8

Li₂S and P₂S₅ were respectively weighed so that the molar ratio thereof becomes 85:15, and mixed, thereby providing a mixture. Relative to 92 moles of this mixture, 8 moles of La₂S₃ was weighed. La is trivalent. The weighed material contains 4.31 mol % of La relative to the entire material. The molar ratio of Li to P is 5.7. The weighed material was pulverized and mixed in a manner similar to Example 1, thereby providing the powder mixture. This powder mixture was subjected to heat treatment for 2 hours at 240° C. The powder mixture after the heat treatment was subjected to XRD measurement. As a result, a plurality of clear diffraction peaks was observed. Thus, the generation of a crystalline phase was confirmed. The ion conductivity was determined in a manner similar to Example 1. As a result, the ion conductivity was 9.9×10⁻⁴ S/cm. Moreover, the electron conductivity was determined by a DC method. As a result, the electron conductivity was 2.8×10⁻⁸ S/cm. Thus, the electron conductivity was negligibly low.

### Example 9

Li₂S and P₂S₅ were respectively weighed so that the molar ratio thereof becomes 65:35, and mixed, thereby providing a mixture. Relative to 92 moles of this mixture, 8 moles of La₂S₃ were weighed. La is trivalent. The weighed material contains 3.60 mol % of La relative to the entire material. The molar ratio of Li to P is 1.9. The weighed material was pulverized and mixed in a manner similar to Example 1, thereby providing the powder mixture. This powder mixture was subjected to heat treatment for 2 hours at 290° C. The powder mixture after the heat treatment was subjected to XRD measurement. As a result, a plurality of clear diffraction peaks was observed. Thus, the generation of a crystalline phase was confirmed. The ion conductivity was determined in a manner similar to Example 1. As a result, the ion conductivity was 10.2×10⁻⁴ S/cm. Moreover, the electron conductivity was determined by a DC method. As a result, the electron conductivity was 2.9×10⁻⁸ S/cm. Thus, the electron conductivity was negligibly low.

### Example 10

Li₂S and P₂S₅ were respectively weighed so that the molar ratio thereof becomes 82:18, and mixed, thereby providing a mixture. Relative to 95 moles of this mixture, 5 moles of La₂S₃ were weighed. La is trivalent. The weighed material contains 2.64 mol % of La relative to the entire material. The molar ratio of Li to P is 4.6. The weighed material was pulverized and mixed in a manner similar to Example 1, thereby providing the powder mixture. This powder mixture was subjected to heat treatment for 2 hours at 240° C. The powder mixture after the heat treatment was subjected to XRD measurement. As a result, a plurality of clear diffraction peaks was observed. Thus, the generation of a crystalline phase was confirmed. The ion conductivity was determined in a manner similar to Example 1. As a result, the ion conductivity was 21.9×10⁻⁴ S/cm. Moreover, the electron conductivity was determined by a DC method. As a result, the electron conductivity was 1.3×10⁻⁸ S/cm. Thus, the electron conductivity was negligibly low.

FIG. 1 is the Z-contrast image of the solid-state lithium ion conductor according to Example 10, which is obtained by transmission electron microscopy. The electron diffraction images at Points 01 to 05 in FIG. 1 are shown in FIG. 2 to FIG. 6, respectively. The detailed crystal structure is unknown. However, in Points 01 to 04, clear spots were observed. This has proved that the portions of Points 01 to 04 are crystalline and have the crystalline phase. Neither spots nor rings were observed in Point 05. This has proved that the portion of Point 05 is amorphous. Thus, it has been confirmed that the solid-state lithium ion conductor is the mixture having both the crystalline phase and the amorphous phase.

### Example 11

Li₂S and P₂S₅ were respectively weighed so that the molar ratio thereof becomes 68:32, and mixed, thereby providing a mixture. Relative to 95 moles of this mixture, 5 moles of La₂S₃ were weighed. La is trivalent. The weighed material contains 2.32 mol % of La relative to the entire material. The molar ratio of Li to P is 2.1. The weighed material was pulverized and mixed in a manner similar to Example 1, thereby providing the powder mixture. This powder mixture was subjected to heat treatment for 2 hours at 240° C. The powder mixture after the heat treatment was subjected to XRD measurement. As a result, a plurality of clear diffraction peaks was observed. Thus, the generation of a crystalline phase was confirmed. The ion conductivity was determined in a manner similar to Example 1. As a result, the ion conductivity was 18.8×10⁻⁴ S/cm. Moreover, the electron conductivity was determined by a DC method. As a result, the electron conductivity was 1.9×10⁻⁸ S/cm. Thus, the electron conductivity was negligibly low.

### Comparative Example 1

Li₂S and P₂S₅ were respectively weighed so that the molar ratio thereof becomes 82:18. In this comparative example, the metal sulfide was not added. The weighed material was pulverized and mixed in a manner similar to Example 1, thereby providing the powder mixture. The powder mixture after the heat treatment was subjected to XRD measurement. As a result, the clear diffraction peak was not observed. This has proved that this powder mixture was in the amorphous state. The ion conductivity was determined in a manner similar to Example 1. As a result, the ion conductivity was 0.6×10⁻⁴ S/cm. Moreover, the electron conductivity was determined by a DC method. As a result, the electron conductivity was 5.2×10⁻⁸ S/cm.

### Comparative Example 2

Li₂S and P₂S₅ were respectively weighed so that the molar ratio thereof becomes 85:15, and mixed, thereby providing a mixture. Relative to 95 moles of this mixture, 5 moles of Sb₂S₃ (Kojundo Chemical Laboratory, product No. SBI02PB) were weighed. Sb is trivalent. The weighed material contains 2.73 mol % of Sb relative to the entire material. The molar ratio of Li to P is 5.7. The weighed material was pulverized and mixed in a manner similar to Example 1, thereby providing the powder mixture. The powder mixture was subjected to XRD measurement. As a result, the clear diffraction peak was not observed. This has proved that this powder mixture is in the amorphous state. The ion conductivity was determined in a manner similar to Example 1. As a result, the ion conductivity was 0.1×10⁻⁴ S/cm. Moreover, the electron conductivity was determined by a DC method. As a result, the electron conductivity was 8.1×10⁻⁸ S/cm. Thus, the electron conductivity was negligibly low.

The above results are shown in Table 1.

TABLE 1

| | | | | | ion | electron | heat | | | molar |
|---|---|---|---|---|---|---|---|---|---|---|
| | | Li₂S + P₂S₅ | metal sulfide | | conductivity | conductivity | treatment | | metal | ratio |
| | | mol % relative to | | mol % relative to | ×10⁻⁴ | ×10⁻⁸ | temperature | | content | of |
| | Li₂S:P₂S₅ | entire material | kind | entire material | S/cm | S/cm | ° C. | valence | mol % | Li to P |
| Example 1 | 85:15 | 99 | ZnS | 1 | 2.5 | 3.2 | Nil | 2 | 0.28 | 5.7 |
| Example 2 | 85:15 | 99 | ZnS | 1 | 4.8 | 3.4 | 240 | 2 | 0.28 | 5.7 |
| Example 3 | 85:15 | 99.5 | La₂S₃ | 0.5 | 3.5 | 2.6 | Nil | 3 | 0.28 | 5.7 |
| Example 4 | 85:15 | 99.5 | La₂S₃ | 0.5 | 6.4 | 2.1 | 250 | 3 | 0.28 | 5.7 |
| Example 5 | 85:15 | 99 | NbS₂ | 1 | 5.9 | 2.9 | 260 | 4 | 0.28 | 5.7 |
| Example 6 | 85:15 | 90 | La₂S₃ | 10 | 6.2 | 2.3 | 240 | 3 | 5.35 | 5.7 |
| Example 7 | 85:15 | 99 | La₂S₃ | 1 | 9.5 | 2.2 | 240 | 3 | 0.55 | 5.7 |
| Example 8 | 85:15 | 92 | La₂S₃ | 8 | 9.9 | 2.8 | 240 | 3 | 4.31 | 5.7 |
| Example 9 | 65:35 | 92 | La₂S₃ | 8 | 10.2 | 2.9 | 290 | 3 | 3.60 | 1.9 |
| Example 10 | 82:18 | 95 | La₂S₃ | 5 | 21.9 | 1.3 | 240 | 3 | 2.64 | 4.6 |
| Example 11 | 68:32 | 95 | La₂S₃ | 5 | 18.8 | 1.9 | 240 | 3 | 2.32 | 2.1 |
| Comparative | 85:15 | 100 | [symbol] | 0 | 0.6 | 7.6 | Nil | — | 0.00 | 5.7 |
| Example 1 | | | | | | | | | | |
| Comparative | 85:15 | 95 | Sb₂S₃ | 5 | 0.1 | 8.1 | Nil | 3 | 2.72 | 5.7 |
| Example 2 | | | | | | | | | | |

Example 1 indicates that the solid-state lithium ion conductor containing Zn has higher ion conductivity than the solid-state lithium ion conductor not containing Zn described in the comparative example. Moreover, the electron conductivity of the solid-state lithium ion conductor containing Zn is negligibly low. Examples 1, 2, 3, and 4 indicate that having the crystalline phase leads to higher ion conductivity. Examples 2, 4, and 5 indicate that the solid-state lithium ion conductor containing trivalent or tetravalent metal has higher ion conductivity. Examples 4, and 6 to 9 indicate that the solid-state lithium ion conductor containing 0.55 to 4.31 mol % of metal has higher ion conductivity. Examples 8 to 11 indicate that when the molar ratio of Li to P is in a range of 2.1 to 4.6, the solid-state lithium ion conductor has higher ion conductivity.

### Examples 12 to 32

The materials were weighed at the composition ratio shown in Table 2, and the weighed materials were pulverized and mixed in a manner similar to Example 1, thereby providing powder mixture. This powder mixture was subjected to heat treatment for 2 hours at temperature shown in Table 2. The ion conductivity and electron conductivity of the powder mixture after the heat treatment are shown in Table 2.

TABLE 2

| | | | | | ion | electron | heat | | | molar |
|---|---|---|---|---|---|---|---|---|---|---|
| | | Li₂S + P₂S₅ | metal sulfide | | conductivity | conductivity | treatment | | metal | ratio |
| | | mol % relative to | | mol % relative to | ×10⁻⁴ | ×10⁻⁸ | temperature | | content | of |
| | Li₂S:P₂S₅ | entire material | kind | entire material | S/cm | S/cm | ° C. | valence | mol % | Li to P |
| Example 12 | 85:15 | 99.5 | Y₂S₃ | 0.5 | 6.1 | 2.3 | 240 | 3 | 0.28 | 5.7 |
| Example 13 | 85:15 | 88 | Y₂S₃ | 12 | 5.8 | 1.9 | 240 | 3 | 6.37 | 5.7 |
| Example 14 | 85:15 | 99 | Y₂S₃ | 1 | 10.1 | 1.7 | 240 | 3 | 0.55 | 5.7 |
| Example 15 | 85:15 | 92 | Y₂S₃ | 8 | 9.9 | 2 | 240 | 3 | 4.31 | 5.7 |
| Example 16 | 65:35 | 92 | Y₂S₃ | 8 | 10.3 | 1.5 | 280 | 3 | 3.60 | 1.9 |
| Example 17 | 82:18 | 95 | Y₂S₃ | 5 | 24.7 | 0.9 | 240 | 3 | 2.64 | 4.6 |
| Example 18 | 68:32 | 95 | Y₂S₃ | 5 | 22.1 | 1.1 | 240 | 3 | 2.32 | 2.1 |
| Example 19 | 85:15 | 99.5 | Ce₂S₃ | 0.5 | 5.9 | 2.8 | 240 | 3 | 0.28 | 5.7 |
| Example 20 | 85:15 | 90 | Ce₂S₃ | 10 | 5.7 | 2.2 | 240 | 3 | 5.35 | 5.7 |
| Example 21 | 85:15 | 99 | Ce₂S₃ | 1 | 9.4 | 1.9 | 240 | 3 | 0.55 | 5.7 |
| Example 22 | 85:15 | 92 | Ce₂S₃ | 8 | 9.7 | 1.4 | 240 | 3 | 4.31 | 5.7 |
| Example 23 | 65:35 | 93 | Ce₂S₃ | 7 | 10.1 | 1.5 | 290 | 3 | 3.15 | 1.9 |
| Example 24 | 82:18 | 94 | Ce₂S₃ | 6 | 23.4 | 1.1 | 240 | 3 | 3.16 | 4.6 |
| Example 25 | 68:32 | 95 | Ce₂S₃ | 5 | 19.5 | 1.2 | 240 | 3 | 2.32 | 2.1 |
| Example 26 | 85:15 | 99 | MoS₂ | 1 | 5.5 | 2.4 | 270 | 4 | 0.28 | 5.7 |
| Example 27 | 85:15 | 82 | MoS₂ | 18 | 6.0 | 2.3 | 270 | 4 | 5.15 | 5.7 |
| Example 28 | 84:16 | 98 | MoS₂ | 2 | 9.1 | 2.1 | 270 | 4 | 0.55 | 5.3 |
| Exampie 29 | 84:16 | 84.7 | MoS₂ | 15.3 | 8.9 | 1.9 | 270 | 4 | 4.31 | 6.2 |
| Example 30 | 65:35 | 86 | MoS₂ | 14 | 9.4 | 2.5 | 290 | 4 | 3.33 | 1.9 |
| Example 31 | 82:18 | 92 | MoS₂ | 8 | 21.5 | 2.8 | 270 | 4 | 2.18 | 4.6 |
| Example 32 | 68:32 | 92 | MoS₂ | 8 | 18.3 | 2.1 | 270 | 4 | 1.91 | 2.1 |

Examples 12 to 18 contain Y, Examples 19 to 25 contain Ce, and Examples 26 to 32 contain Mo. Examples 12 to 32 indicate that the solid-state lithium ion conductor containing each metal by 0.55 to 4.31 mol % has higher ion conductivity. Moreover, it is known that when the molar ratio of Li to P is in a range of 2.1 to 4.6, the solid-state lithium ion conductor has higher ion conductivity. Moreover, in Examples 12 to 32, the electron conductivity was 10⁻⁷ S/em or less, which was negligibly low.

### Examples 33 to 65

The materials were weighed at the composition ratio shown in Table 3, and the weighed materials were pulverized and mixed in a manner similar to Example 1, thereby providing powder mixture. In most of the examples, a metal sulfide was used as the transition metal element source. In Example 34 where Pr was used, Example 41 where Ho was used, Example 55 where Ru was used, Example 56 where Os was used, and Example 59 where Ir was used, however, each single metal element and single sulfur were mixed at a molar ratio shown in the table and used. This powder mixture was subjected to heat treatment for 2 hours at temperature shown in Table 3. The ion conductivity and electron conductivity of the powder mixture after the heat treatment are shown in Table 3.

TABLE 3

| | | Li₂S + P₂S₅ | metal sulfide | | | | | | | |
|---|---|---|---|---|---|---|---|---|---|---|
| | | mol % | | mol % | ion | electron | heat | | | molar |
| | | relative to | | relative to | conductivity | conductivity | treatment | | metal | ratio |
| | | entire | | entire | ×10⁻⁴ | ×10⁻⁸ | temperature | | content | of |
| Example | Li₂S:P₂S₅ | material | kind | material | S/cm | S/cm | ° C. | valence | mol % | Li to P |
| Example 33 | 82:18 | 95 | Sc₂S₃ | 5 | 20.2 | 2.1 | 240 | 3 | 2.64 | 4.6 |
| Example 34 | 82:18 | 95 | metalPr:sulfur = | 5 | 18.5 | 1.5 | 230 | 3 | 2.64 | 4.6 |
| | | | 2:3 | | | | | | | |
| Example 35 | 82:18 | 95 | Nd₂S₃ | 5 | 19.1 | 1.3 | 230 | 3 | 2.64 | 4.6 |
| Example 36 | 82:18 | 95 | Sm₂S₃ | 5 | 22.0 | 1.2 | 240 | 3 | 2.64 | 4.6 |
| Example 37 | 82:18 | 95 | Eu₂S₃ | 5 | 18.6 | 1.3 | 230 | 3 | 2.64 | 4.6 |
| Example 38 | 82:18 | 95 | Gd₂S₃ | 5 | 22.1 | 0.8 | 230 | 3 | 2.64 | 4.6 |
| Example 39 | 82:18 | 95 | Tb₂S₃ | 5 | 24.1 | 0.9 | 240 | 3 | 2.64 | 4.6 |
| Example 40 | 82:18 | 95 | Dy₂S₃ | 5 | 23.7 | 1.2 | 230 | 3 | 2.64 | 4.6 |
| Example 41 | 82:18 | 95 | metalHo:sulfur = | 5 | 19.3 | 1.7 | 240 | 3 | 2.64 | 4.6 |
| | | | 2:3 | | | | | | | |
| Example 42 | 82:18 | 95 | Eu₂S₃ | 5 | 18.7 | 1.8 | 220 | 3 | 2.64 | 4.6 |
| Example 43 | 82:18 | 95 | Tm₂S₃ | 5 | 19.3 | 1.5 | 230 | 3 | 2.64 | 4.6 |
| Example 44 | 82:18 | 95 | Yb₂S₃ | 5 | 22.1 | 1.6 | 230 | 3 | 2.64 | 4.6 |
| Example 45 | 82:18 | 95 | Lu₂S₃ | 5 | 20.4 | 1.8 | 220 | 3 | 2.64 | 4.6 |
| Example 46 | 82:18 | 92 | ZrS₂ | 8 | 22.7 | 2.7 | 250 | 4 | 2.18 | 4.6 |
| Example 47 | 82:18 | 92 | HfS₂ | 8 | 22.4 | 2.5 | 250 | 4 | 2.18 | 4.6 |
| Example 48 | 82:18 | 95 | V₂S₃ | 5 | 20.8 | 1.9 | 240 | 3 | 2.64 | 4.6 |
| Example 49 | 82:18 | 92 | NbS₂ | 8 | 19.5 | 2.4 | 220 | 4 | 2.18 | 4.6 |
| Example 50 | 82:18 | 92 | TaS₂ | 8 | 22.9 | 2.3 | 220 | 4 | 2.18 | 4.6 |
| Example 51 | 82:18 | 95 | Cr₂S₃ | 5 | 23.9 | 2.2 | 230 | 3 | 2.64 | 4.6 |
| Example 52 | 82:18 | 92 | WS₂ | 8 | 20.5 | 2.3 | 270 | 4 | 2.18 | 4.6 |
| Example 53 | 82:18 | 92 | MnS | 8 | 15.8 | 5.1 | 250 | 2 | 2.23 | 4.6 |
| Example 54 | 82:18 | 92 | ReS₂ | 8 | 22.7 | 3.1 | 270 | 4 | 2.18 | 4.6 |
| Example 55 | 82:18 | 92 | metalRu:sulfur = | 8 | 21.8 | 2.5 | 270 | 4 | 2.18 | 4.6 |
| | | | 1:2 | | | | | | | |
| Example 56 | 82:18 | 92 | metalOs:sulfur = | 8 | 21.7 | 3.2 | 270 | 4 | 2.18 | 4.6 |
| | | | 1:2 | | | | | | | |
| Example 57 | 82:18 | 92 | CoS | 8 | 14.9 | 4.8 | 230 | 2 | 2.23 | 4.6 |
| Example 58 | 82:18 | 92 | RhS₂ | 8 | 22.3 | 2.4 | 270 | 4 | 2.18 | 4.6 |
| Example 59 | 82:18 | 92 | metalIr:sulfur = | 8 | 20.6 | 2.5 | 260 | 4 | 2.18 | 4.6 |
| | | | 1:2 | | | | | | | |
| Example 60 | 82:18 | 92 | NiS | 8 | 13.7 | 3.9 | 220 | 2 | 2.23 | 4.6 |
| Example 61 | 82:18 | 92 | PdS | 8 | 14.8 | 4.1 | 270 | 2 | 2.23 | 4.6 |
| Example 62 | 82:18 | 92 | PtS₂ | 8 | 22.1 | 2.3 | 270 | 4 | 2.18 | 4.6 |
| Example 63 | 82:18 | 92 | ZnS | 8 | 18.9 | 4.2 | 240 | 2 | 2.23 | 4.6 |
| Example 64 | 82:18 | 92 | CdS | 8 | 16.2 | 4.8 | 240 | 2 | 2.23 | 4.6 |
| Example 65 | 82:18 | 92 | HgS | 8 | 15.9 | 4.5 | 230 | 2 | 2.23 | 4.6 |

As indicated in Table 3, the ion conductivity in all the examples was higher than that of the comparative example. Moreover, the electron conductivity was 10⁻⁷ S/cm or less, which was negligibly low.

### Examples 66 to 70

The materials were weighed at the composition ratio shown in Table 4, and the weighed materials were pulverized and mixed in a manner similar to Example 1, thereby providing powder mixture. This powder mixture was subjected to heat treatment for 2 hours at the temperature shown in Table 4. The ion conductivity and electron conductivity of the powder mixture after the heat treatment are shown in Table 4.

TABLE 4

| | | Li₂S + | metal | | | | | | heat | | | | |
|---|---|---|---|---|---|---|---|---|---|---|---|---|---|
| | | P₂S₅ | sulfide 1 | | metal sulfide 2 | | ion | electron | treat- | | | | |
| | | mol % | | mol % | | mol % | conduc- | conduc- | ment | | | | molar |
| | | relative | | relative | | relative | tivity | tivity | temper- | | | metal | ratio |
| | | to entire | | to entire | | to entire | ×10⁻⁴ | ×10⁻⁸ | ature | valence | | content | of |
| Example | Li₂S:P₂S₅ | material | kind | material | kind | material | S/cm | S/cm | ° C. | metal1 | metal2 | mol % | Li to P |
| Example 66 | 82:18 | 96 | Sc₂S₃ | 2 | Y₂5₃ | 2 | 20.9 | 1.1 | 240 | 3 | 3 | 2.12 | 4.6 |
| Example 67 | 82:18 | 94 | MoS₂ | 2 | Ce₂S₃ | 4 | 21.8 | 2.5 | 270 | 4 | 3 | 2.66 | 4.6 |
| Example 68 | 82:18 | 94 | Cr₂S₃ | 3 | Tb₂S₃ | 3 | 19.5 | 1.9 | 240 | 3 | 3 | 3.16 | 4.6 |
| Example 69 | 82:18 | 94 | NiS | 4 | Dy₂S₃ | 2 | 15.7 | 3.4 | 220 | 2 | 3 | 2.18 | 4.6 |
| Example 70 | 82:18 | 90 | ZrS₂ | 6 | V₂5₃ | 4 | 19.9 | 2.1 | 240 | 4 | 3 | 3.76 | 4.6 |

In Examples 66 to 70 containing two kinds of metal elements, the ion conductivity was higher than that in the comparative example. Moreover, the electron conductivity was 10⁻⁷ S/cm or less, which was negligibly low.

As thus described, it has been confirmed that the solid-state lithium ion conductor having both higher ion conductivity and low electron conductivity can be obtained in the embodiment according to the present disclosure. The solid-state lithium ion conductor as above can be used for an electrochemical device such as a lithium ion secondary battery.

By the use of the solid-state lithium ion conductor with high ion conductivity according to this embodiment, the all-solid-state lithium ion secondary battery (electrochemical device) with higher performance can be obtained. This all-solid-state lithium ion secondary battery is used as a power source for a mobile electronic appliance. The all-solid-state lithium ion secondary battery is also applicable to electric vehicles or home-use or industrial-use storage batteries. Moreover, the solid-state lithium ion conductor according to this embodiment can be used for other electrochemical devices than the lithium ion secondary battery, such as a primary battery, a secondary battery, an electrochemical capacitor, a fuel cell, or a gas sensor.

The solid-state lithium ion conductor and the electrochemical device of this embodiment may be any of the following first to fifth solid-state lithium ion conductors and first electrochemical device.

A first solid-state lithium ion conductor contains Li, P, and S, and at least one metal element selected from Sc, Y, La, Ce, Pr, Nd, Sm, Eu, Gd, Tb, Dy, Ho, Er, Tm, Yb, Lu, Zr, Hf, V, Nb, Ta, Cr, Mo, W, Mn, Re, Ru, Os, Co, Rh, Ir, Ni, Pd, Pt, Zn, Cd, and Hg.

A second solid-state lithium ion conductor is the first solid-state lithium ion conductor having a crystalline phase.

A third solid-state lithium ion conductor is the first or second solid-state lithium ion conductor wherein the metal element is trivalent or tetravalent.

A fourth solid-state lithium ion conductor is any of the first to third solid-state lithium ion conductors wherein the metal element has a content of 0.55 to 4.31 mol %.

A fifth solid-state lithium ion conductor is any of the first to fourth solid-state lithium ion conductors wherein the molar ratio of Li to P is in a range of 2.1 to 4.6.

A first electrochemical device contains any of the first to fifth solid-state lithium ion conductors.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A solid-state lithium ion conductor comprising:
Li, P, and S; and
at least one metal element selected from Sc, Y, La, Ce, Pr, Nd, Sm, Eu, Gd, Tb, Dy, Ho, Er, Tm, Yb, Lu, Zr, Hf, V, Nb, Ta, Cr, Mo, W, Mn, Re, Ru, Os, Co, Rh, Ir, Ni, Pd, Pt, Zn, Cd, and Hg.

2. The solid-state lithium ion conductor according to claim 1, further comprising a crystalline phase.

3. The solid-state lithium ion conductor according to claim 1, wherein the solid-state lithium ion conductor is a mixture of an amorphous material free of a crystalline phase and a crystalline material having a crystalline phase.

4. The solid-state lithium ion conductor according to claim 1, wherein the metal element is trivalent or tetravalent.

5. The solid-state lithium ion conductor according to claim 1, wherein the metal element has a content of 0.55 to 4.31 mol %.

6. The solid-state lithium ion conductor according to claim 1, wherein the molar ratio of Li to P is in a range of 2.1 to 4.6.

7. The solid-state lithium ion conductor according to claim 1, further comprising a cation other than Li, P, and the metal element.

8. The solid-state lithium ion conductor according to claim 1, further comprising an anion other than S.

9. An electrochemical device containing the solid-state lithium ion conductor according to claim 1.
